(19) United States
(12) Patent Application Publication
(10) Pub. No.: US 2005/0058029 A1
(43) Pub. Date: Mar. 17, 2005

(54) Method for controlling the tracking on action of an optical disk drive

(76) Inventors: Jen-Yu Hsu, Sindian City (TW); Hsiang-Yi Fu, Hsinchu City (TW); Tun-Chieh Lee, Hsinchu City (TW); Fu-Hsiang Chen, Jhongli City (TW)

Correspondence Address: Raymond Sun, 12420 Woodhall Way, Tustin, CA, 92782, US

(21) Appl. No.: 10/938,377

(22) Filed: Sep. 10, 2004

(30) Foreign Application Priority Data
Sep. 15, 2003 (TW) 92125295

(51) Int. Cl. G11B 7/00

(52) U.S. Cl. 369/44.28; 369/44.25

(57) ABSTRACT

A method of controlling the tracking action of an optical disk drive is disclosed. According to the method, the number of sine waves in the tracking error signals is calculated while the disk drive is conducting a long seek, to determine the number of tracks crossed by the optical pick up head. When the disk drive is about to perform tracking on action, the actual speed of the sledge is estimated by estimating the frequency of alternating high and low levels in an optical signal detected by the optical receiver. The tracking on action is carried out if the speed of the sledge is below a threshold value.

### BACKGROUND OF THE INVENTION

1. Field of the Invention

The present invention relates to a method for controlling the tracking on action of an optical disk drive, and in particular, to a method for controlling the tracking on action of an optical disk drive after a long seek.

2. Description of the Prior Art

A compact disk is a storage medium that permits random access. To fulfill this function, an optical disk drive, such as a compact disk drive, must be capable of delivering the sledge to the target position in a precise manner at any moment in the fastest time possible using the seeking servo system, at which point the tracking servo system takes over to perform the tracking following action of the optical pick up head. The “tracking on action” refers to the timing of switching from the seeking servo system to the tracking servo system.

FIG. 1 shows schematically the tracking on action of the optical pick up head of a conventional compact disk drive. In general, during a long seek in a compact disk drive, a seeking servo system is used to control a sledge 26 until it arrives at the target position (or target track), and then a tracking servo system controls the tracking following action of the optical pick up head 24. A movable range 27 is defined on the sledge 26 to provide for fine-tuning by the optical pick up head 24 when the optical pick up head 24 is performing tracking on action, track following action, or short seeking. In general, when the optical pick up head 24 is not subjected to any control, a flexible element 25 will control the optical pick up head 24 such that the optical pick up head 24 remains in the center position of the movable range 27. In FIG. 1, when the sledge 26 moves to the target position, the tracking servo system can be switched to control the optical pick up head 24 such that it locks on the target track 23 on the compact disk 22, and then follows the target track 23 to reproduce the information on the target track 23. In other words, the “tracking on action” occurs when the tracking servo system is switched to lock on the target track 23, and the “track following action” refers to when the tracking servo system controls the optical pick up head to follow the target track 23.

As a rule, the tracking error signals that are generated while the seeking servo system is in control represent the number of tracks that have already been crossed by the optical pick up head 24 that is driven by the sledge 26. When the optical pick up head 24 crosses a track, the tracking error signal will pass the zero-crossing point to appear as a sine wave. As a result, when conducting a long seek, the compact disk drive can estimate the distance between the optical pick up head 24 and the target position by calculating the number of sine waves in the tracking error signals, and then it can perform tracking on action when the optical pick up head 24 arrives at the target position.

FIG. 2 is a diagram of the sledge motor output curve during a long seek conducted by a compact disk drive. In order to control the movement of the sledge 26, a feed motor output (FMO) signal is provided for the sledge motor 30 that drives the sledge 26 in the compact disk drive. To achieve a rapid access to the data stored on the compact disk 22 when the compact disk drive is conducting a long seek (see times t0-t1), the feed motor output (FMO) must be relatively large in order to drive the sledge 26. When the sledge 26 is getting close to the target position (t1), the feed motor output must be gradually reduced. When the sledge 26 arrives at the target position, the optical pick up head 24 can perform the tracking on action smoothly due to the reduced speed of the sledge 26.

In general, the compact disk drive uses the tracking error signals to determine the speed of the sledge 26. When the optical pick up head 24 crosses a track, the tracking error signal will pass a zero-crossing point to appear as a sine wave, and the frequency of the sine waves can be used to estimate the speed of the sledge 26. As can be seen in the curve of the sledge motor output shown in FIG. 2, a high sine wave frequency will show up as the tracking error signal between t0 and t1, but the sine wave frequency will gradually decrease after time t1. As a result, when the frequency of the tracking error signals decreases below a certain point, it can be determined that the speed of the sledge 26 at this point allows the tracking on action to be carried out.

However, the above-described method for estimating the sine wave frequency of the tracking error signals can in fact produce errors itself. Due to the fact that the optical pick up head 24 is connected to the sledge 26 by only a flexible element 25, the optical pick up head 24 will oscillate irregularly within the movable range 27 when the sledge 26 is forced to move at high speed. When the optical pick up head 24 is about to perform the tracking on action, but the speed of the sledge 26 does not yet allow tracking on action, if the optical pick up head 24 then moves opposite to the sledge direction at this point, there may be a significant decrease in the sine wave frequency of the tracking error signals that are detected by the compact disk drive. If at this point the compact disk drive performs the tracking on action after determining that the sledge speed had decreased enough for the tracking on action, the sledge 26 will still have a certain speed from inertia, and not only will it be impossible for the optical pick up head 24 to lock onto the target track 23 successfully, but an unstable state can also result due to the oscillation of the optical pick up head 24 within the movable range 27.

Due to the fact that the direction of movement between the sledge 26 and the optical pick up head 24 is not defined, errors can occur in the speed of the sledge 26 as reflected by the sine wave frequency of the tracking error signals, resulting in failure of the tracking on action in the compact disk drive.

### SUMMARY OF THE DISCLOSURE

It is an object of the present invention to provide a method of controlling the tracking on action after a long seek which prevents failure of the tracking on action.

It is another object of the present invention to provide a method of controlling the tracking action after a long seek conducted by a compact disk drive, such that the speed of a sledge can be determined to be below a threshold speed when the compact disk drive is about to perform tracking on action.

It is yet another object of the present invention to provide a method of controlling the tracking action after a long seek conducted by a compact disk drive, such that the frequency of alternating high and low levels of a received optical signal can be determined to be below a threshold when the compact disk drive is about to perform tracking on action.

In order to accomplish the objects of the present invention, the present invention provides a method of controlling the tracking action of an optical disk drive. According to the method, the number of sine waves in the tracking error signals is calculated while the disk drive is conducting a long seek, to determine the number of tracks crossed by the optical pick up head. When the disk drive is about to perform tracking on action, the actual speed of the sledge is estimated by estimating the frequency of alternating high and low levels in an optical signal detected by the optical receiver. The tracking on action is carried out if the speed of the sledge is below a threshold value.

The present invention provides another method of controlling the tracking action of an optical disk drive. According to this method, the number of sine waves in the tracking error signals is calculated while the disk drive is conducting a long seek, to determine the number of tracks crossed by the optical pick up head. When the disk drive is about to perform tracking on action, the frequency of alternating high and low levels in an optical signal detected by the optical receiver is estimated. The tracking on action is carried out if the estimated frequency is below a threshold value.

### BRIEF DESCRIPTION OF THE DRAWINGS

FIG. 1 illustrates the tracking action being carried out by an optical pick up head of a conventional optical disk drive.

FIG. 2 depicts the curve of the sledge motor output while the optical disk drive is conducting a long seek.

FIG. 3 illustrates an embodiment of an optical disk drive according to the present invention with the sledge being driven by the sledge motor.

FIG. 4 illustrates an optical signal generator that can be used with the optical disk drive of the present invention.

FIG. 5 illustrates a method of controlling tracking following a long seek carried out by an optical disk drive according to the present invention.

FIG. 6 illustrates another method of controlling tracking following a long seek carried out by an optical disk drive according to the present invention.

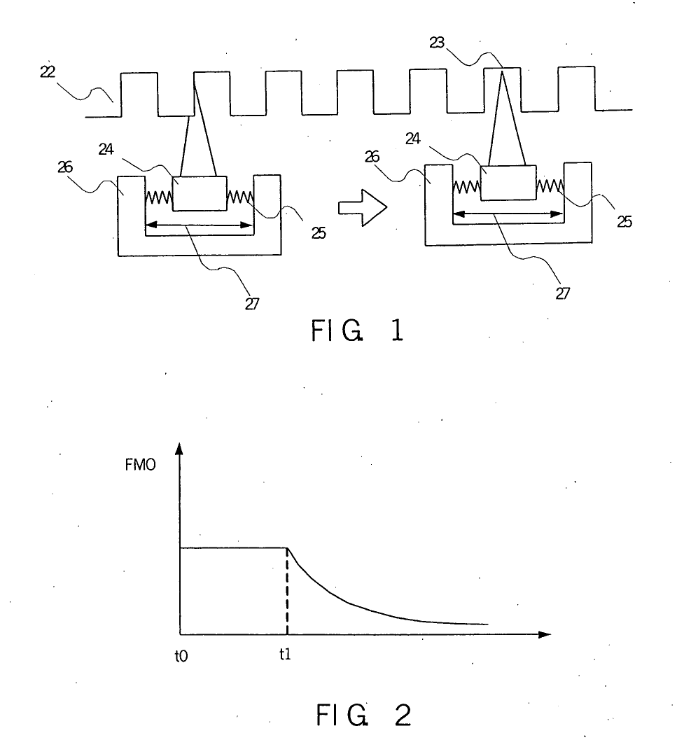

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

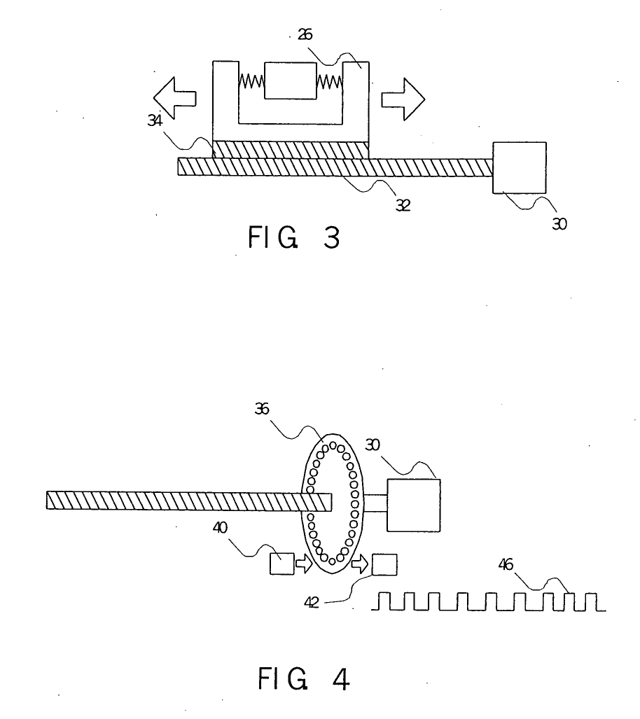

FIG. 3 illustrates a sledge 26 that can be used with an optical disk drive, such as a compact disk drive, of the present invention. The sledge 26 is provided with a gear 34, which is engaged with a helical guiding rod 32 of a sledge motor 30. Thus, when the sledge motor 30 rotates, it causes the sledge 26 to move in a lateral direction. When the compact disk drive is performing a long seek, the rotation of the sledge motor 30 is used to drive the sledge 26 and an optical pick up head 24 (carried on the sledge 26) to move laterally.

FIG. 4 illustrates a photo-optical signal generator of a compact disk drive according to the present invention. In order to detect the rotational speed of the sledge motor 30, a spherical optical screen 36 is installed on the helical guiding rod 32 of the sledge motor 30. The spherical optical screen 36 functions as a photo-interrupter, and rotates synchronously with the sledge motor 30. An optical emitter 40 and an optical receiver 42 are positioned in an aligned manner on two opposing sides of the spherical optical screen 36. When the light beam of the optical emitter 40 is constantly interrupted by the spherical optical screen 36, a photo signal 46 with alternating high and low levels can be generated by the optical receiver 42. Because the gear 34 of the sledge 26 is engaged with the helical guiding rod 32, the actual speed of the sledge 26 can be estimated based on the frequency of the alternating high and low levels in the photo signal 46.

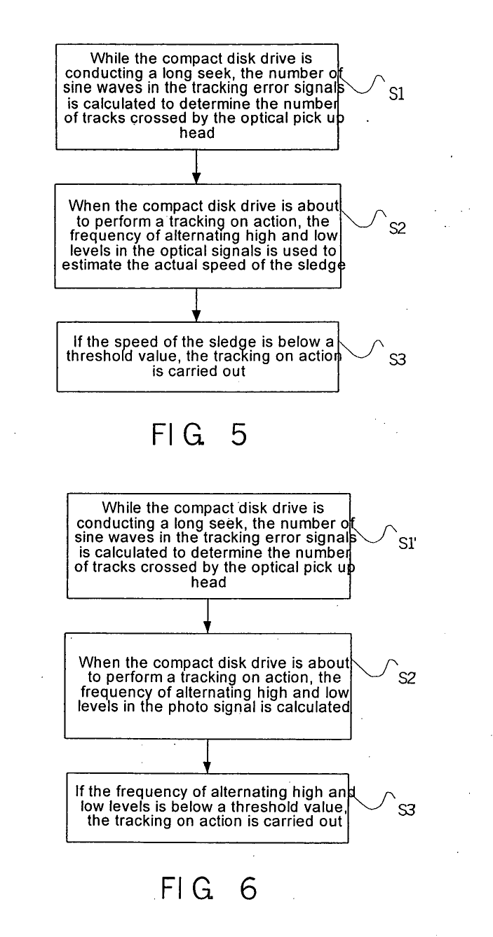

FIG. 5 illustrates a method of controlling the tracking on action after a long seek conducted by an optical disk drive, such as a compact disk drive. There are three separate steps: S1, S2 and S3.

Step S1: While the compact disk drive is conducting a long seek, the number of sine waves in the tracking error signals is calculated to determine the number of tracks crossed by the optical pick up head 24.

Step S2: When the compact disk drive is about to perform a tracking on action, the frequency of alternating high and low levels in the photo signal 46 is used to estimate the actual speed of the sledge 26.

Step S3: If the speed of the sledge 26 is below a threshold value, the tracking on action is carried out.

Based on the application examples of the present invention, the actual speed can be calculated accurately using the photo signals 46 with alternating high and low levels. As a result, the inaccurate sledge speed obtained using tracking error signals (as per the prior art) can be corrected, and the timing for the compact disk drive to perform tracking on action can be accurately determined. Thus, the present invention minimizes the likelihood of a tracking on failure in the compact disk drive.

In addition, the present invention not only uses the photo signals 46 to estimate the actual speed of the sledge, but the present invention can also be achieved based on the frequency of the photo signals 46. For example, a threshold frequency can be preset for a compact disk drive, and when the frequency of the photo signals 46 is below the threshold value, the compact disk drive can perform the tracking on action. FIG. 6 is a flow-chart illustrating this modified method, which is essentially the same as the method of FIG. 5 except that the frequency of the alternating high and low levels in the photo signals 46 is calculated (see step S2′), and this calculated frequency is compared to a threshold value (see step S3′). In this way, tracking on action can be carried out without having to obtain the actual speed of the sledge 26.

Therefore, the advantages of the present invention are to propose a method of controlling the tracking on action after a long seek conducted by a compact disk drive, wherein the actual speed can be calculated using the photo signals 46 with alternating high and low levels so that the compact disk drive will not misjudge the sledge speed and tracking on action can be carried out successfully.

While the description above refers to particular embodiments of the present invention, it will be understood that many modifications may be made without departing from the spirit thereof. The accompanying claims are intended to cover such modifications as would fall within the true scope and spirit of the present invention.

1. A method of controlling the tracking action of an optical disk drive that has an optical receiver, and a sledge that carries an optical head, comprising:
while the disk drive is conducting a long seek, calculating the number of sine waves in the tracking error signals to determine the number of tracks crossed by the optical pick up head;
when the disk drive is about to perform tracking on action, estimating an actual speed of the sledge by estimating the frequency of alternating high and low levels in an optical signal detected by the optical receiver; and
carrying out tracking on action if the actual speed of the sledge is below a threshold value.

2. The method of claim 1, further including:
further providing the optical disk drive a motor coupled to the sledge, and an optical screen rotating synchronously with the motor, with an optical emitter and the optical receiver positioned in an aligned manner on two opposing sides of the optical screen.

3. A method of controlling the tracking action of an optical disk drive that has an optical receiver, and a sledge that carries an optical head, comprising:
while the disk drive is conducting a long seek, calculating the number of sine waves in the tracking error signals to determine the number of tracks crossed by the optical pick up head;
when the disk drive is about to perform tracking on action, estimating a frequency of alternating high and low levels in an optical signal detected by the optical receiver; and
carrying out tracking on action if the frequency of alternating high and low levels is below a threshold value.

4. The method of claim 3, further including:
further providing the optical disk drive a motor coupled to the sledge, and an optical screen rotating synchronously with the motor, with an optical emitter and the optical receiver positioned in an aligned manner on two opposing sides of the optical screen.
